(19) United States
(12) Patent Application Publication
(10) Pub. No.: US 2026/0118507 A1
(43) Pub. Date: Apr. 30, 2026

(54) VESSEL FOR USE IN SUBSEA SURVEYING AND METHOD OF ACQUIRING SUBSEA SURVEY DATA

(71) Applicant: FNV IP B.V., Leidschendam (NL)

(72) Inventor: Simon Howard MCILROY, Leidschendam (NL)

(73) Assignee: FNV IP B.V., Leidschendam (NL)

(21) Appl. No.: 19/120,572

(22) PCT Filed: Aug. 18, 2023
(86) PCT No.: PCT/EP2023/072797

§ 371 Date: Apr. 11, 2025

(30) Foreign Application Priority Data
Oct. 24, 2022 (NL) 2033380

(51) Int. Cl. G01S 15/89; B63B 1/28; B63B 79/15; B63G 8/00

(52) U.S. Cl. CPC G01S 15/89; B63B 1/28; B63B 79/15; B63G 8/001; B63B 2211/02; B63G 2008/005

(57) ABSTRACT

Sustainable method and environmentally-friendly device for improved survey data acquisition by providing a vessel for use in subsea surveying, at least one lifting hydrofoil, a method of acquiring subsea survey data, a method of producing a vessel, and the use of a vessel. Unlocking insights from Geo-Data, the present invention further relates to improvements in sustainability and environmental developments: together we create a safe and liveable world.

### FIELD OF THE INVENTION

The present disclosure generally relates to a vessel for use in subsea surveying, and more particularly to at least one lifting hydrofoil for use with a vessel for subsea surveying, a method of acquiring subsea survey data, a method of producing a vessel, and the use of a vessel. Unlocking insights from Geo-Data, the present invention further relates to improvements in sustainability and environmental developments: together we create a safe and liveable world.

### BACKGROUND OF THE INVENTION

There is a general and ongoing need to improve the quality and speed of subsea surveying. In subsea surveying, at least one sensor is provided underneath the surface of a body of water, such as sea, rivers, or lakes. These sensors are provided to capture surveying data which relates to characteristics of the subsea environment. This surveying data may for example be related, but not limited, to the geometry of the seabed, detecting e.g., boulders, and mapping the seabed for various subsea operations. Surveying data may also be related to detecting subsurface objects, buried below the seabed, such as pipelines, unexploded ordinances such as sea mines, or the like. Further, the surveying data may be related to the soil types below the seabed, which may be relevant to pre-engineering surveys for e.g., wind farm foundations.

During the acquisition of subsea surveying data generally involves providing sensors below the surface of the water, such that the sensors can detect characteristics which are linked to the subsea environment. Different types of sensors have different types of requirements and limitations. Sensors that are dragged behind a vessel or are attached to the hull of a vessel often encounter problems of e.g., unstable conditions, leading to limited data quality. For example, noise from the interactions between the hull and the water may affect the data quality. Vibrations from the propulsion of the vessel may affect the sensors. The movement of the vessel through the water may lead to entrained water, i.e., water mixed with air, around the hull of the vessel, which has significant effects on the data acquisition from the sensors. Further, the water moving past the hull will provide a turbulent boundary layer, the stochastic vortices of which may also negatively impact the quality of the data acquired by the sensors.

The quality of data acquisition is known to reduce with increased speed, which can also affect the quality of sensor data as more ambient noise will be generated through the increase of the water velocity with respect to the hull of the vessel. Roughness on the vessel surface can induce additional turbulence in the boundary layer of the water flow, which may also affect the signal quality. An additional problem associated with increased velocity is increased drag, which limits the efficiency of the vessel. Since the surveying often takes long periods of time and can be in remote areas, efficiency of the propulsion of the vessel is of high importance.

Attempts have been made to improve the data quality as well as the efficiency of data acquisition, while minimizing energy expenditure. Sensors have been known to be introduced in a gondola, below the hull of a vessel. A gondola is a structure below the waterline of a vessel, positioned at a distance from the hull of the vessel, which is provided at a depth such that interferences such as waves are minimized. The stability of sensors in a gondola is higher than the stability of sensors in the hull of a vessel. For example, since the gondola does not breach the waterline, there are less problems associated with entrained water and highly stochastic turbulent boundary layers, which affect the data quality.

However, the provision of sensors in a gondola provides additional limitations, such as increased drag, lower efficiency, increased weight, and increased draft.

Hydrofoil ships are known to increase the efficiency of a ship. A hydrofoil system is provided to the ship such that the ship is lifted from the water when it reaches a certain velocity, due to the lifting force of the hydrofoil. However, the use of a gondola to store the sensors, or sensors being provided in the hull of a vessel, is incompatible with the use of hydrofoils. When the vessel is lifted from the water, the sensors are also lifted. The sensors may be lifted from the water entirely, or to the extent that they are provided in a less stable region, closer to the waterline of the vessel. For example, waves could provide significant interference with the sensor data if they are not provided at a sufficient depth. In addition, the increased speed required to attain lift for the vessel leads to much higher drag forces on the gondola, leading to drastically reduced efficiencies. The gondola strongly increases drag and introduces instabilities to the sensors, such that data quality is reduced. Furthermore, the gondola must be more robust to withstand this increased drag, even further increasing propulsion requirements and decreasing efficiency.

The known state of the art for subsea surveying thus does not provide a solution for acquisition of high-quality data while minimizing energy expenditure.

There is a need for an improved subsea surveying vessel and methods for acquiring subsea surveying data that addresses the issues explained above.

### BRIEF SUMMARY OF THE INVENTION

In one aspect of the invention there is provided a vessel for use in subsea surveying. The vessel comprises a hull. The vessel further comprises at least one lifting hydrofoil. The vessel comprises a connection structure for connecting the at least one lifting hydrofoil to the hull. The connection structure is arranged to translate a lifting force from the at least one lifting hydrofoil to the hull of the vessel. The at least one lifting hydrofoil comprises at least one surveying sensor. By providing the vessel with at least one lifting hydrofoil, the efficiency of the vessel is increased. By providing at least one surveying sensor in the lifting hydrofoil, the stability of the sensor is increased, thus improving the data quality.

The sensor stability refers to the consistency of the generated data with constant environmental characteristics. The stability of the at least one surveying sensor is dependent on, inter alia, its interactions with the water flowing past the sensor. For example, the formation of entrained water, in which air is mixed with the water, will strongly affect the stability of the sensor due to its stochastic nature and high energy density. In other words, the entrained water carries kinetic energy which develops a strongly stochastic response in the sensors. Furthermore, noise generated by the interactions of the hull with the water may negatively affect results of sound-based sensors. The formation of a turbulent boundary layer also generates a stochastic response in the sensors as vortices are formed around the sensors, which may affect the data quality and sensor stability. A turbulent boundary layer is formed on a surface as the water flows past it over a certain length. At first, the boundary layer is laminar and as the water increases in speed, and the velocity profile between the surface and the water is lowered, a transition from laminar to turbulent flow in the boundary layer occurs. This turbulent boundary layer is stochastic and negatively influences the sensor if it is positioned beyond the transition point between laminar and turbulent flow.

Lifting hydrofoils have not been used in surveying procedures as the hull of the vessel and/or the gondola containing the sensors, would be lifted from the water, or closer to the surface of the water. This would strongly decrease the sensor stability and result in surveying data which does not meet quality requirements.

The present invention however addresses these drawbacks by positioning the at least one surveying sensor in the lifting hydrofoil. The expression “the at least one surveying sensor in the lifting hydrofoil” is to be understood as being placed within the hydrofoil, either at the surface of said hydrofoil such that the surveying sensor forms part of the outer surface of the lifting hydrofoil, or in the body of the hydrofoil, depending on the type of used surveying sensor. While the hull of the vessel is raised closer to or out of the water surface, the lifting hydrofoil remains under water. The lifting hydrofoil in the present invention is also positioned in the water, further away from the surface of the water (deeper into the water) such that disturbances such as, e.g., waves, have less of an effect on the sensors. In addition, as the lifting hydrofoil is positioned away from the water surface, the effects of entrained water on the sensor stability are also reduced. Furthermore, since the lifting hydrofoil is arranged to lift the hull of the vessel and reduce its wetted surface, total noise generation through the interaction of the hull with the water is further reduced, leading to improved measurement results. Since a lifting hydrofoil generally has a relatively low length and high width, the lifting hydrofoil has a relatively high proportion of surface area where the boundary layer is laminar. The flow over the lifting hydrofoil may in some embodiments even be completely laminar. This further improves the data quality of the sensors.

The movement of the vessel through the water may lead to entrained water, i.e., water mixed with air, around the hull of the vessel, which has significant effects on the data acquisition from the sensors. Further, the water moving past the hull will provide a turbulent boundary layer, the stochastic vortices of which may also negatively impact the quality of the data acquired by the sensors.

The efficiency of the vessel is improved by reducing the drag of the vessel and improving the energy consumption as a result. The drag of the vessel is reduced by the reduction of friction drag by the hull, as well as the optional removal of the gondola from the hull of the vessel. The improvement of energy efficiency helps create a more sustainable vessel for use in subsea surveying which is more environmentally friendly compared with traditional surveying vessels.

A vessel may be any buoyant or semi-buoyant structure arranged to move relative to the seabed, such as a ship, boat, barge, submarine, and the like. The hull of the vessel is any outer surface of the vessel, including, but not limited to, the wetted surface underneath the waterline, the outer surface above the waterline, or e.g., the deck. The wetted surface of the hull is the surface of the hull in contact with the water. The connection structure provides a connection between the hull and the lifting hydrofoil. This connection may be direct or indirect. For example, the connection structure may directly connect the lifting hydrofoil to the underside of the hull, or e.g., the sides of the hull above the waterline. The connection may also be formed through a structure on the deck of the vessel, e.g., through an over-the-side hydrofoil which is pivotably attached to the deck via e.g., a mounting structure. Alternatively, or additionally, the hydrofoil may be connected to a structure above the deck, such as a crane or frame. Such an indirect connection structure is also arranged to translate a lifting force form the lifting hydrofoil to the hull of the vessel.

When the vessel is stationary, the gravitational force exerted to the vessel is balanced with the force exerted to the water by the displacement of the water, causing a buoyancy force. This buoyancy force is related to the wetted surface of the hull of the vessel, since it is indicative of the volume of displaced water causing the buoyancy force, together with the shape of the hull. A problem associated with this wetted surface is that it also provides friction when the vessel is moving, in the form of e.g., frontal drag, and friction drag.

When the vessel is moving, the lifting hydrofoil generates a lifting force, which reduces the required buoyancy force. In a balanced situation, the buoyancy force of the wetted surface and the lifting force of the lifting hydrofoil are equal to the gravitational force on the vessel. In the event where the hull is lifted from the water completely, the lifting force of the hydrofoil is substantially equal to the gravitational force on the vessel, and the buoyancy force is substantially zero. As such, the lifting hydrofoil of the present disclosure is arranged to reduce the wetted surface of the vessel.

The connection structure may be integrally formed with the hull and lifting hydrofoil. In such an embodiment, the hull is formed such that the connection structure is integrally formed, rather than being attached at a later stage by e.g., welding, or modular connections. The connection structure may also be integrally formed with the lifting hydrofoil.

In an embodiment, the connection structure may further be utilized to provide a data transmission and/or power transmission channel to power the one or more sensors and to transmit the data gathered from the sensors. In an alternative, or additional, embodiment, the lifting hydrofoil may comprise a power source and/or a data storage unit, such as a hard drive to store the surveying data once data has been gathered from the environment.

The lifting hydrofoil is arranged to provide a lifting force to the hull of the vessel through the connection structure. The lifting hydrofoil may be any lifting body, surface, or foil, that is arranged to operate in water. The lifting force is generated by the pressure differential between a top and bottom surface of the lifting hydrofoil. The pressure differential is generally generated through the curvature or shape of the hydrofoil on the top and bottom surfaces. The difference in the water flow over the top and bottom surfaces of the hydrofoil creates a pressure differential such that the pressure on the top surface of the foil is lower than the pressure on the bottom of the foil, resulting in a net upward pressure. This net upward pressure and the area over which this pressure is applied on the lifting foil result in a lifting force, which reduces the wetted surface of the vessel and thus its frontal, and friction drag, thus increasing the efficiency of the vessel.

In a preferred embodiment, the vessel comprises a plurality of lifting hydrofoils. The vessel may comprise two or more lifting hydrofoils. The vessel may comprise four or more lifting hydrofoils. The vessel may comprise six or more lifting hydrofoils. The plurality of lifting hydrofoils may all be connected to the hull of the vessel through a connection structure. The plurality of lifting hydrofoils may be connected to the hull via a single connection structure. Alternatively, the plurality of lifting hydrofoils may all have a separate connection structure. In an embodiment, the plurality of lifting hydrofoils is connected to the hull of the vessel via a plurality of connection structures, such that a single connection structure may connect one or more of the plurality of lifting hydrofoils to the hull of the vessel.

Surveying sensors are any sensors that provide information on the environment of the vessel, i.e., any characteristics not related to the vessel itself. Surveying data is the information acquired form the surveying sensors. Surveying sensors are understood to exclude sensors relating to characteristics of the vessel and/or the hydrofoil itself, such as motion sensors, accelerometers, gyroscopic sensors, or the like. Surveying sensors in the context of the present disclosure relate solely to sensors providing information about the environment of the vessel.

In an embodiment, the at least one surveying sensor comprises at least one sensor of the group of: sonar systems such as Echosounders; Single-beam, Beamforming Multibeam, Sub Bottom profiling systems; Acoustic Doppler systems, Interferometric sonar systems including Side-scan sonar and Swath bathymetry systems; Laser ranging systems including lidar and Laser stripping with accompanying camera vision technologies. In the context of the present disclosure, the term surveying sensor is understood to comprise sonar systems, including a transmitter and/or a receiver. In an embodiment, the sensor may comprise the receiver by itself, or the transmitter by itself.

By using such surveying sensors, the vessel can be used for oceanographic research and collection of geodata. In particular, sonar systems generally relate to techniques that use sound propagation to navigate, measure distances, communicate with or detect objects on or under the surface of the water, or even under the seabed. Two general types of sonar systems may be considered. First, passive sonar utilizes existing propagation waves to measure environment characteristics, such as detection of seabed characteristics, or the detection of sub-bottom objects, such as pipelines, soil types, pipelines, or the like. Passive sonar essentially utilizes ambient propagation waves which are not actively generated by the measurement instrument.

Another type of sonar system is an active system, in which the sensor is emitting pulses or continuous strings of waves and listening for reflected propagation waves. Sonar may be used as a means of acoustic location and of measurement of the echo characteristics of “targets” in the water, above the water, or below the seabed in the subsea soil.

Echosounders are systems that use sonar for ranging systems, normally to derive the depth of water and to map the seabed, which is also known as bathymetry. Acoustic waves are transmitted into the water and the time of flight between the transmission and the receipt of the return signal is measured. By using information relating to the speed of sound in water, the time of flight of the signal between transmission and receipt provides the total depth. Single-beam echosounders determine the depth at a given position based on the travel time of a short sonar pulse. A multibeam echosounder utilizes a fan-shaped array of signals to provide information two dimensions, the height of the seabed over a line. The fan advantageously expands laterally to the direction of movement of the surface vessel, which leads to a three-dimensional mapping of the seabed, providing information on the height (2) of the seabed (i.e., the water depth) over two dimensions (x, y). To extract directional information from the returning propagation waves, the multibeam echosounder utilizes beamforming, or spatial filtering to determine directional signal transmission time of flight. This is advantageously done through combining elements in an antenna array in such a way that signals at particular angles experience constructive interference while other experience destructive interference. Beamforming can be used at both the transmitting and the receiving ends in order to achieve spatial selectivity. The improvement compared with omnidirectional reception and/or transmission is known as the directivity of the array.

Acoustic Sub-Bottom Profiling (SBP) systems are used to determine physical properties of the sea floor and to image and characterise geological information a few metres below the sea floor. Sub-bottom profilers are usually comprised of single channel source that sends sound pulses into the shallow sub-sea floor sediments. The sound pulses bounce off the sea floor and subsequent buried sediment layers according to differences in their acoustic impedance (hardness). Acoustic impedance is related to the density of the material and the rate at which sound travels through this material. The different times taken for this signal to be returned and recorded by the sub-bottom profiler indicate how deep the layers are below the sea floor. The surface of the different rock strata beneath the sea floor are mapped over the study area.

An Acoustic Doppler Current Profiler, or Acoustic Doppler Profiler, is often referred to with the acronym ADCP. The system is used to measure how fast water is moving across an entire water column. The ADCP measures water currents with sound, using a principle of sound waves called the Doppler effect. The ADCP works by transmitting “pings” of sound at a constant frequency into the water. As the sound waves travel, they ricochet off particles suspended in the moving water, and reflect back to the instrument. Due to the Doppler effect, sound waves bounced back from a particle moving away from the profiler have a slightly lowered frequency when they return. Particles moving toward the instrument send back higher frequency waves. The difference in frequency between the waves the profiler sends out and the waves it receives is called the Doppler shift. The instrument uses this shift to calculate how fast the particle and the water around it are moving.

Sound waves that hit particles far from the profiler take longer to come back than waves that strike close by. By measuring the time of flight of the waves to bounce back and the Doppler shift, the profiler can measure current speed at many different depths with each series of pings.

A swath-sounding sonar system is used to measure the depth in a line extending outward from the sonar transducer. As the survey vessel moves along a track line, the swath transducer sends out sonar signals at a right-angles to the track line and is scanning the seabed to each side of the vessel. It sweeps out an area of depth measurements, referred to as a swath. The word interferometric refers to the technique used to measure soundings. The interferometric technique uses the phase content of the sonar signal to measure the wave front that is returned from the seafloor or other targets such as a seawall.

Side-scan uses a sonar device that emits conical or fan-shaped pulses down toward the seafloor across a wide angle perpendicular to the path of the sensor through the water, which may be towed from a surface vessel or submarine or mounted on the ship's hull. The intensity of the acoustic reflections from the seafloor of this fan-shaped beam is recorded in a series of cross-track slices. When stitched together along the direction of motion, these slices form an image of the sea bottom within the swath (coverage width) of the beam. The sound frequencies used in side-scan sonar usually range from 100 to 500 KHz; higher frequencies yield better resolution but less range.

Lidar is a method for determining ranges (variable distance) by targeting an object or a surface with a laser and measuring the time for the reflected light to return to the receiver. It can also be used to make digital three-dimensional representations of areas on the Earth's surface and ocean bottom of the intertidal and near coastal zone by varying the wavelength of light. It has terrestrial, airborne, and mobile applications. Lidar is an acronym of “light detection and ranging” or “laser imaging, detection, and ranging”. It is sometimes called 3-D laser scanning, a special combination of 3-D scanning and laser scanning.

Lidar uses ultraviolet, visible, or near infrared light to image objects. It can target a wide range of materials, including non-metallic objects, rocks, rain, chemical compounds, aerosols, clouds, and even single molecules. A narrow laser beam can map physical features with very high resolutions; for example, an aircraft can map terrain at 30-centimetre (12 in) resolution or better.

When using sonar transducers, the transmitter is advantageously provided in a direction, parallel to the direction of movement of the lifting hydrofoil. The receiver is advantageously positioned laterally, extending in a direction between two distal ends of the hydrofoil, substantially orthogonal to the direction of movement of the lifting hydrofoil. Substantially orthogonal to the direction of movement is understood to mean between about 80 and 100 degrees to the direction of movement of the lifting hydrofoil. In an advantageous embodiment, the receiver extends exactly orthogonal to the direction of movement of the lifting hydrofoil, i.e., defining a 90 degree angle with the direction of movement.

In an embodiment, at least one surveying sensor comprises at least one sonar system, being positioned in the hydrofoil on the bottom face towards the aft of the foil, i.e., at a back region of the hydrofoil, relative to the direction of travel.

In an embodiment wherein the vessel comprises two or more lifting hydrofoils, the sonar system is advantageously positioned towards a back region of the vessel. In an embodiment, the vessel is uncrewed, i.e., arranged to be controlled and operated remotely and without the need of personnel on the vessel to control and operate the vessel. An uncrewed vessel is also designated as uncrewed surface vessel or autonomous surface vessel. Such an embodiment is advantageous since it reduced the need for human interaction with the physical vessel at sea. Rather, operations may be controlled remotely such that risk of personnel being injured is reduced. In addition, as personnel no longer needs to be on board of the vessel, its size may be reduced. As the vessel no longer requires space for personnel, such as working, sleeping, eating, leisure spaces, the vessel may be much smaller and lighter. This aids in energy efficiency and helps create a more sustainable and environmentally friendly vessel. In an alternative embodiment, the vessel is crewed. This includes fully crewed vessels or partially crewed vessels. Partially crewed vessels are understood to encompass vessel wherein a portion of the operations are performed remotely, and a portion are done physically on the vessel. Such a vessel may only require one or several crew members, such as surveyors, on board to perform the tasks for which physical presence is required. The rest of the operation is then performed remotely, to minimize personnel presence on the vessel. By at least partially controlling and operating the vessel remotely, the impact of personnel on safety and vessel size may be reduced. In an embodiment, the vessel comprises a launch and recovery system (LARS) for the use of a remotely operated vessel/vehicle (ROV). An ROV may be deployed from the vessel to perform further investigations and/or operations at e.g., infrastructure sites. An ROV LARS may be provided such that further explorations, inspections, and/or maintenance procedures or the like may be undertaken in a single operation. That is, the vessel may directly respond to something which is identified using the one or more surveying sensors in the lifting hydrofoil of the vessel. For example, if the one or more surveying sensors identify a fault in a pipeline, an ROV may be deployed using a LARS, such that the fault may be further investigated and/or remedied in a single vessel operation.

By positioning the sonar system towards the aft of the foil, interference caused by hydrodynamics is reduced. The sensor optimally operates when a lamina flow of fluid is provided over the surface of the transducer. Disturbances in this flow directly impact the performance of the sensor and its ability to collect high quality accurate data. The shape of the hydrofoil and sensor placement is optimised to minimise the disturbance and interference cause by the passage of the body through the water.

In an embodiment, the lifting hydrofoil comprises a high-tensile material, advantageously at least one of Glass-Reinforced Plastic (GRP), also known as fibreglass, high-density polyethylene (HDPE), polyamides such as homopolymers and copolymers of PA46, PA48, PA410, PA46/6T, PA4T, PA6, PA610, PA6T, PA6/6T, PA6/10T, PA910, PA9T, polyesters, nylon, carbon fibre, plastics, polymers, advantageously ultra-high molecular weight polymers (such as ultra-high molecular weight polyethylene), ultra-high density polymers (such as ultra-high density polyethylene), polyoxymethylene, resins, polyamides, polyether ether ketones, or polycarbonates. In the context of the present invention, the term ‘polymer’ is to be understood as a homopolymer or a copolymer. In an embodiment, the lifting hydrofoil comprises at least about 50%, advantageously at least about 70%, more advantageously at least about 90% of non-magnetic, advantageously non-conductive, more advantageously non-metal materials. In an embodiment, the lifting hydrofoil comprises aluminium, titanium and/or steel.

In a preferred embodiment, the lifting hydrofoil comprises a composite material, advantageously GRP. The use of a composite material is advantageous since it has high strength, low corrosion, and can be fabricated with a degree of flexibility of shapes and sizes.

In an embodiment, the lifting hydrofoil extends in a lateral direction between a first and second distal end. The lifting hydrofoil may comprise a front end and a tail end, extending in a movement direction substantially orthogonal to the lateral direction between the first and second distal ends. A centre point may be defined between the first and second distal ends. In an embodiment, the connection structure connects to the lifting hydrofoil at the centre point.

Attaching the connection structure to the lifting hydrofoil at the centre point provides a stable lifting point such that the moment around the connection structure is limited in relation to the lifting force generated by the lifting hydrofoil. By way of example, embodiments where the connection structure is connected to a single distal end of the lifting hydrofoil, while appropriate in some situations, a bending moment will be provided to the connection structure, requiring a larger structural integrity of the connection structure.

In an embodiment, the lifting hydrofoil comprises an elongated section, extending in the direction of movement, the elongated section extending between a frontal tip and a posterior end, the centre point being positioned between the frontal tip and the posterior end. In an embodiment, the elongated section of the lifting hydrofoil comprises a propulsion device. In a preferred embodiment, the propulsion device comprises a motor and a propeller, the motor and propeller being connected by a longitudinal shaft.

In a preferred embodiment, a transmitter of a multibeam echosounder transmitter is provided in the elongated section, the transmitter extending in the direction of movement of the hydrofoil. In a preferred embodiment, the longitudinal shaft, the motor, and the propeller are provided at the centre point of the lifting hydrofoil, in the elongated section. The arrangement of providing a propulsion device at the centre point of the lifting hydrofoil, and the connection structure similarly being attached at the centre point of the lifting hydrofoil, allows the multibeam echosounder transducers to be arranged in an optimal Mills cross arrangement. In such an arrangement, the receiver is provided between the first and second distal ends of the hydrofoil, extending in a direction substantially orthogonal to the direction of movement, and the transmitter is provided in the elongated section such that it extends in a direction substantially parallel to the direction of movement.

In an embodiment, the lifting hydrofoil comprises a bottom surface, wherein the bottom surface comprises an acoustically transparent window. In an embodiment, the lifting hydrofoil comprises an acoustic sensor, such as a multibeam echosounder transducer. Other acoustic sensors may also be provided in the lifting hydrofoil. Advantageously, the acoustic sensor is positioned adjacent to, advantageously above, the acoustically transparent window. In a preferred embodiment, acoustic signals transmitted or received through the acoustically transparent window are propagated while minimizing transmission loss. As such, an acoustic signal received by the acoustic sensor, provides a high data quality while minimizing impact on the hydrodynamic characteristics of the lifting hydrofoil.

The provision of an acoustically transparent window allows the sensor to be positioned in the lifting hydrofoil, which minimises impact to the sensor, while maintaining good signal quality. In addition, the provision of the sensor behind an acoustically transparent window maintains the hydrodynamic requirements of the lifting hydrofoil. As such, lifting characteristic of the lifting hydrofoil is limited while maintaining optimal signal quality. In an embodiment, the acoustically transparent window has high transmission of sound and little absorption and diffraction of sound, thus minimizing signal loss due to transmission. Transmission loss in general describes the accumulated decrease in intensity of a waveform energy as a wave propagates outwards from a source, or as it propagates through a certain area or through a certain type of structure. Measurement of transmission loss can be in terms of decibels. In an embodiment, the acoustically transparent window is formed of a polymer material, advantageously polyoxymethylene (POM).

In an embodiment, the lifting hydrofoil comprises a rigid internal skeleton structure. The provision of a rigid internal skeleton structure allows for a stiff mounting structure to secure the at least one surveying sensors to. This allows the outer profile of the wing to adapt in shape as required for optimal foiling. The use of a rigid internal skeleton structure, while allowing the outer surface of the hydrofoil to attain flexibility advantageously allows the sensors to be provided at predetermined positions, without limiting the hydrodynamic properties of the lifting hydrofoil.

In an embodiment, the rigid internal skeleton structure comprises a material having a modulus of elasticity of at least about 30 GPa, advantageously of at least about 50 GPa, more advantageously of at least about 70 GPa, still more advantageously of at least about 90 GPa. In an advantageous embodiment, the rigid internal skeleton structure comprises a high-tensile material, advantageously at least one of Glass-Reinforced Plastic (GRP), also known as fibreglass, high-density polyethylene (HDPE), polyamides such as homopolymers and copolymers of PA46, PA48, PA410, PA46/6T, PA4T, PA6, PA610, PA6T, PA6/6T, PA6/10T, PA910, PA9T, polyesters, nylon, carbon fibre, plastics, polymers, advantageously ultra-high molecular weight polymers (such as ultra-high molecular weight polyethylene), ultra-high density polymers (such as ultra-high density polyethylene), polyoxymethylene, resins, polyamides, polyether ether ketones, or polycarbonates. In the context of the present invention, the term ‘polymer’ is to be understood as a homopolymer or a copolymer. In an embodiment, the rigid internal skeleton structure comprises at least about 50%, advantageously at least about 70%, more advantageously at least about 90% of non-magnetic, advantageously non-conductive, more advantageously non-metal materials. In an embodiment, the lifting hydrofoil comprises aluminium, titanium and/or steel.

In an embodiment, the connection structure is arranged to adapt the distance between the lifting hydrofoil and the hull of the vessel. In a preferred embodiment, the connection structure is a telescopic structure, arranged to extend and retract to increase or decrease the distance between the hydrofoil and the hull.

By allowing such adaptation of the distance between the hull and the lifting hydrofoil, the depth of the one or more surveying sensors can be controlled. This allows the vessel to operate in shallow waters at low speed, such that the lifting force generated by the lifting hydrofoil is insufficient to raise the vessel from the water. In such situations, the depth of the lifting hydrofoil can be reduced, to prevent a collision of the hydrofoil with the seabed. Similarly, if the vessel is operated in deep waters at high speed, such that the vessel is completely raised from the water, the distance between the hull and the hydrofoil can be increased to provide sufficient depth for stable data acquisition.

In an embodiment, the lifting hydrofoil is arranged to provide a lifting force such that a wetted surface of the hull of the vessel is reduced by at least about 20%, advantageously by at least about 40%, more advantageously by at least about 60%, still more advantageously by at least about 80%.

Such a lifting force allows for the reduction of wetted surface, thereby reducing hydrodynamic drag of the water to the vessel, thus increasing its efficiency and speed. Since the lifting hydrofoil comprises at least one surveying sensor, raising the vessel does not lead to sensors being lifted out of the water, or in the waves. As a result, the force increases efficiency and speed, but does not affect the ability of the vessel to acquire the desired surveying data.

In a preferred embodiment, the lifting hydrofoil is arranged to provide a lifting force such that a wetted surface of the hull of the vessel is reduced by 100%, such that the hull is lifted from the water in its entirety, only leaving the lifting hydrofoil and a section of the connection structure in the water.

In an embodiment, the vessel has a length of between about 1 m and 200 m, advantageously of between about 5 m and 100 m, more advantageously of between about 10 m and 80 m, still more advantageously of between about 20 m and 60 m. In an embodiment, the maximum width of the vessel is between about 0.5 m and 50 m, advantageously between about 1 m and 40 m, more advantageously of between about 5 m and 30 m, still more advantageously of between 10 m and 25 m. In a preferred embodiment, the vessel has a weight of between about 100 kg and 500 tonnes, advantageously of between 1 tonne and 200 tonnes, more advantageously of between 10 tonnes and 100 tonnes, still more advantageously of between 20 tonnes and 60 tonnes.

In a preferred embodiment, the lifting hydrofoil has a width, spanning from a first distal end to a second distal end of between about 0.5 m and 50 m, advantageously between about 1 m and 40 m, more advantageously of between about 5 m and 30 m, still more advantageously of between 10 m and 25 m. In a preferred embodiment, the vessel comprises a plurality of lifting hydrofoils having a width, spanning from a first distal end to a second distal end of between about 0.5 m and 50 m, advantageously between about 1 m and 40 m, more advantageously of between about 5 m and 30 m, still more advantageously of between 10 m and 25 m.

According to an aspect of the invention, there is provided a lifting hydrofoil for use with a vessel for subsea surveying, the lifting hydrofoil being arranged to connect to a connection structure for connecting the lifting hydrofoil to a hull of the vessel, wherein the lifting hydrofoil comprises at least one surveying sensor.

The embodiments discussed in relation to the vessel according to the invention may equally be applied to the lifting hydrofoil.

In an embodiment, the at least one surveying sensor comprises at least one sensor of the group of: sonar systems such as Echosounders; Single-beam, Beamforming Multibeam, Sub Bottom profiling systems; Acoustic Doppler systems, Interferometric sonar systems including Side-scan sonar and Swath bathymetry systems; Laser ranging systems including lidar and Laser stripping with accompanying camera vision technologies.

According to an aspect of the invention, there is provided a method of acquiring subsea survey data comprising the steps of: providing a vessel according to any of the embodiments disclosed herein; submerging the hydrofoil of the vessel in water; moving the vessel such that the hydrofoil defines a velocity with respect to the seabed; and acquiring surveying data from the at least one surveying sensor.

According to an aspect of the invention, there is provided a method of producing a vessel according to any the embodiments disclosed herein, comprising the steps of: providing a hull of a vessel; providing a lifting hydrofoil according to any of the embodiments disclosed herein; providing a connection structure for connecting the lifting hydrofoil to the hull, the connection structure being arranged to translate a lifting force from the lifting hydrofoil to the hull of the vessel; and attaching the connection structure to the lifting hydrofoil and the hull of the vessel.

According to an aspect of the invention, there is provided the use of a vessel according to any of the embodiments disclosed herein for acquiring subsea surveying data.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are therefore not to be considered to be limiting of its scope, the principles herein are described and explained with additional specificity and detail through the use of the accompanying drawings in which:

FIG. 1 is a three-dimensional view of one embodiment of the invention showing a lifting hydrofoil;

FIG. 2 is a three-dimensional view of one embodiment of the invention showing a vessel for use in subsea surveying;

FIG. 3 is a three-dimensional view of one embodiment of the invention showing a vessel for use in subsea surveying; and

FIG. 4 is a schematic diagram showing a method of acquiring subsea surveying data according to an embodiment of the invention.

### DESCRIPTION OF ILLUSTRATIVE EMBODIMENTS

The following is a description of certain embodiments of the invention, given by way of example only and with reference to the drawings.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. A reference to an embodiment in the present disclosure can be a reference to the same embodiment or any other embodiment. Such references thus relate to at least one of the embodiments herein.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

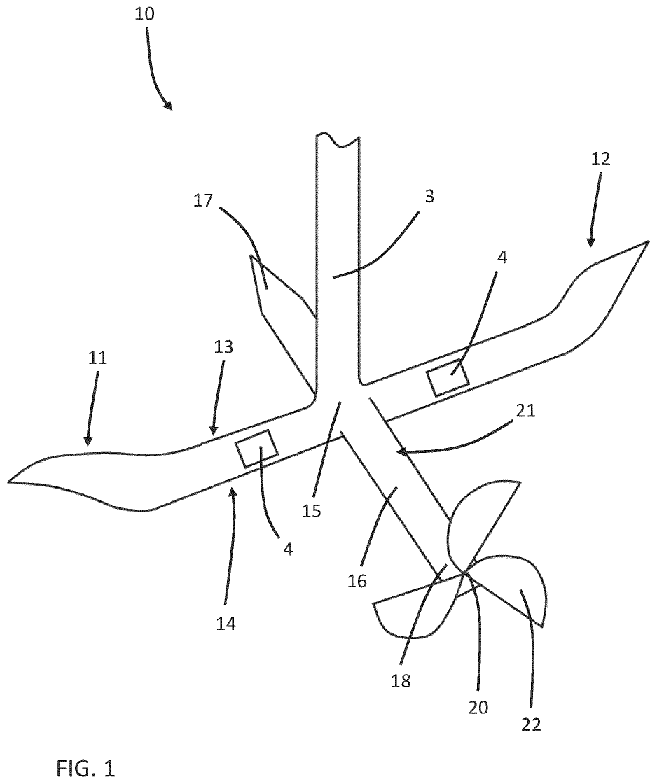

Referring to FIG. 1, a three-dimensional view of a lifting hydrofoil 10 is shown. The lifting hydrofoil 10 of the shown embodiment is arranged for use with a vessel for subsea surveying. The lifting hydrofoil 10 is arranged to connect to a connection structure 3, which provides a connection between the lifting hydrofoil 10 and the hull 2 of a vessel 1. In the shown embodiment, the connection structure 3 forms an integral connection with the lifting hydrofoil 10. The lifting hydrofoil comprises at least one surveying sensor 4. The at least one surveying sensor may be any appropriate surveying sensor 4.

In an embodiment, the at least one surveying sensor 4 comprises at least one sensor of the group of: sonar systems such as Echosounders; Single-beam, Beamforming Multibeam, Sub Bottom profiling systems; Acoustic Doppler systems, Interferometric sonar systems including Side-scan sonar and Swath bathymetry systems; Laser ranging systems including lidar and Laser stripping with accompanying camera vision technologies.

In the shown embodiment, the lifting hydrofoil extends in a lateral direction between a first 11 and second 12 distal end, and wherein the lifting hydrofoil 10 comprises a front end 13 and a tail end 14, extending in a movement direction substantially orthogonal to the lateral direction, wherein a centre point 15 is defined between the first 11 and second 12 distal ends. In the shown embodiment, the connection structure 3 connects to the lifting hydrofoil 10 at the centre point 15. As a result, the lifting force generated by the lifting hydrofoil 10 translates to a lifting force on the hull 2 of the vessel 1 such that the lifting force from the lifting hydrofoil 10 provides a balanced upward force.

In the shown embodiment, the lifting hydrofoil 10 comprises an elongated section 16. The elongated section 16 extends in the direction of movement of the vessel 1 and the lifting hydrofoil 10. The elongated section 16 extends between a frontal tip 17 and a posterior end 18. The centre point 15 is positioned between the frontal tip 17 and the posterior end 18.

In the shown embodiment, the elongated section 16 of the lifting hydrofoil 10 comprises a propulsion device 20. The propulsion device 20 comprises a motor 21, advantageously positioned in the elongated section 16, and a propeller 22. The motor 21 and the propeller 22 are advantageously connected by a longitudinal shaft between the motor 21 and the propeller 22.

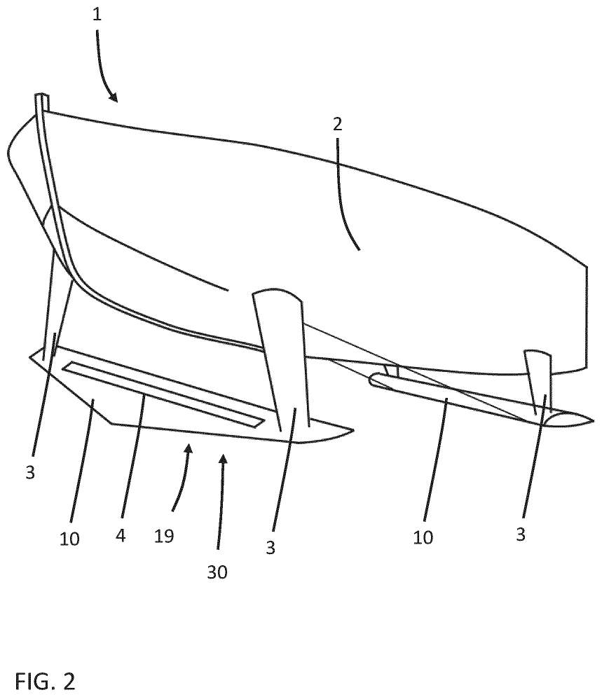

Now referring to FIG. 2, a vessel 1 for use in subsea surveying is shown. The vessel 1 comprises a hull 2, a lifting hydrofoil 10, and a connection structure 3 for connecting the lifting hydrofoil 10 to the hull 2 of the vessel 1. In the shown embodiment, the vessel 1 comprises two lifting hydrofoils 10 being spaced at a distance in the direction of movement of the vessel 1. Each of the two lifting hydrofoils 10 are connected to the hull 2 of the vessel 10 via two connection structures 3. The connection structures 3 connect to the lifting hydrofoil 10 at two laterally distanced positions. Similarly, the connections structures 3 connect to the hull 2 of the vessel 1 at two laterally positioned locations on the vessel. As a result, a stable position of the vessel 1 is attained.

The lifting hydrofoil 10 of the shown embodiment comprises at least one surveying sensor 4 according to any one of the embodiments disclosed herein. In an embodiment, the lifting hydrofoil 10 comprises a bottom surface 19, and the bottom surface comprises an acoustically transparent window 30. In an embodiment, the lifting hydrofoil 10 comprises an acoustic sensor 4, such as a multibeam echosounder transducer. Other acoustic sensors may also be provided in the lifting hydrofoil 10. The acoustic sensor 4 is positioned adjacent to, advantageously above, the acoustically transparent window 30. Acoustic signals transmitted or received through the acoustically transparent window 30 are propagated while minimizing transmission loss. As such, an acoustic signal received by the acoustic sensor 4, provides a high data quality while minimizing impact on the hydrodynamic characteristics of the lifting hydrofoil 10.

The provision of an acoustically transparent window 30 allows the sensor to be positioned in the lifting hydrofoil 10, which minimises impact to the sensor 4, while maintaining good signal quality. In addition, the provision of the sensor 4 behind an acoustically transparent window 30 maintains the hydrodynamic requirements of the lifting hydrofoil 10. As such, lifting characteristic of the lifting hydrofoil 10 is limited while maintaining optimal signal quality.

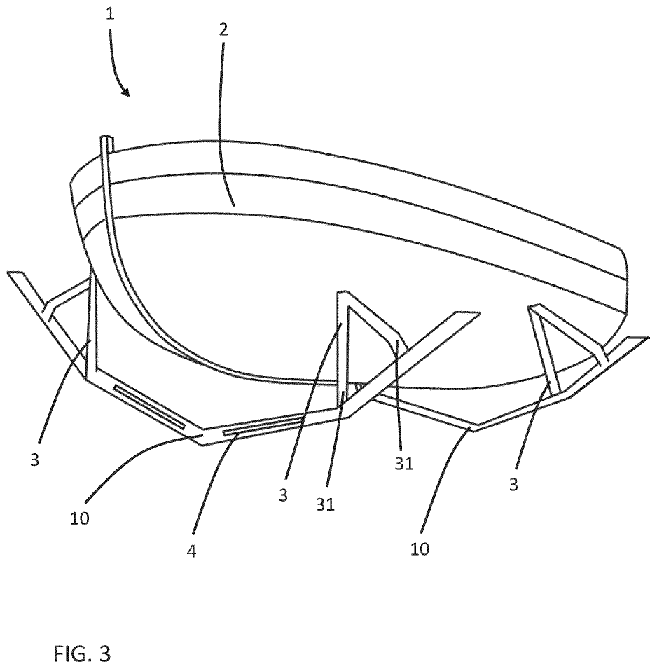

Now referring to FIG. 3, another embodiment of a vessel 1 for subsea surveying is shown. In the shown embodiment, the vessel 1 comprises a hull 2, and two arched lifting hydrofoils 10. The lifting hydrofoils 10 are connected to the hull 2 via a plurality of connection structures 3. In the shown embodiment, the connection structures 3 each comprise two struts 31 extending from the hydrofoil 10 to the hull 2 of the vessel 1. This further increases the structural integrity of the connection structure 3 between the lifting hydrofoils 10 and the vessel 2 and increases the resistance to lateral movement of the vessel 1 with respect to the water.

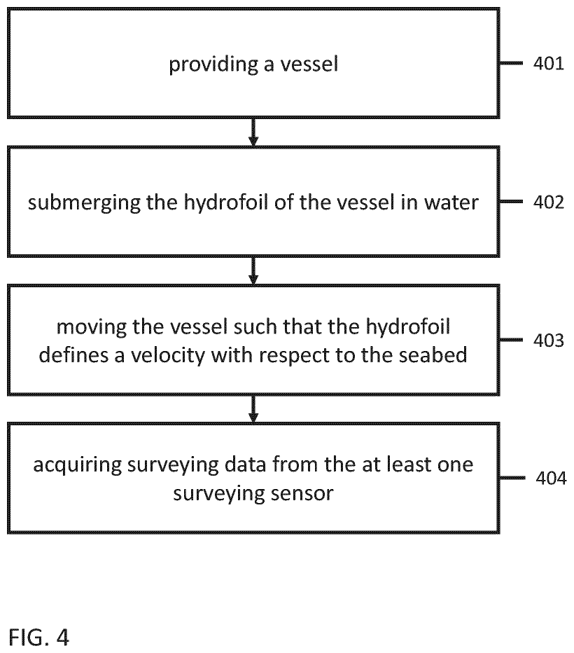

Now referring to FIG. 4, a schematic diagram outlining a method of acquiring subsea survey data is shown, outlining the steps of providing 401 a vessel according to any of the embodiments disclosed herein, submerging 402 the hydrofoil of the vessel in water, moving 403 the vessel such that the hydrofoil defines a velocity with respect to the seabed, and acquiring 404 surveying data from the at least one surveying sensor.

The invention has been described by reference to certain embodiments discussed above. It will be recognized that these embodiments are susceptible to various modifications and alternative forms well known to those of skill in the art.

Further modifications in addition to those described above may be made to the structures and techniques described herein without departing from the spirit and scope of the invention. Accordingly, although specific embodiments have been described, these are examples only and are not limiting upon the scope of the invention.

1. A vessel for use in subsea surveying, the vessel comprising:
a hull;
at least one lifting hydrofoil; and
a connection structure for connecting the at least one lifting hydrofoil to the hull, the connection structure being arranged to translate a lifting force from the at least one lifting hydrofoil to the hull of the vessel,
wherein the at least one lifting hydrofoil comprises at least one surveying sensor.

2. The vessel of claim 1, wherein the at least one surveying sensor comprises at least one sonar system.

3. The vessel of claim 1, wherein the vessel is uncrewed.

4. The vessel of claim 1, further comprising a launch and recovery system for use of a remotely operated vessel/vehicle (ROV).

5. The vessel of claim 1, wherein the at least one surveying sensor comprises at least one sonar system, being positioned in the at least one lifting hydrofoil at a back region of the at least one lifting hydrofoil, relative to its intended direction of movement.

6. The vessel of claim 1, wherein the at least one lifting hydrofoil extends in a lateral direction between a first and second distal end, and wherein the at least one lifting hydrofoil comprises a front end and a tail end, extending in a movement direction substantially orthogonal to the lateral direction, wherein a centre point is defined between the first and second distal ends, and wherein the connection structure connects to the at least one lifting hydrofoil at the centre point.

7. The vessel of claim 1, wherein the at least one lifting hydrofoil comprises a bottom surface, wherein the bottom surface comprises an acoustically transparent window, and wherein the at least one lifting hydrofoil comprises an acoustic sensor.

8. The vessel of claim 1, wherein the at least one lifting hydrofoil comprises a rigid internal skeleton structure.

9. The vessel of claim 1, wherein the connection structure is arranged to adapt a distance between the at least one lifting hydrofoil and the hull of the vessel.

10. (canceled)

11. (canceled)

12. (canceled)

13. A method of acquiring subsea survey data, the method comprising steps of:
providing a vessel, the vessel including:
at least one lifting hydrofoil; and
a connection structure for connecting the at least one lifting hydrofoil to a hull of the vessel, the connection structure being arranged to translate a lifting force from the at least one lifting hydrofoil to the hull of the vessel,
wherein the at least one lifting hydrofoil comprises at least one surveying sensor;
submerging the at least one lifting hydrofoil of the vessel in water;
moving the vessel such that the at least one lifting hydrofoil defines a velocity with respect to a seabed; and
acquiring surveying data from the at least one surveying sensor.

14. (canceled)

15. (canceled)

16. The method of claim 13, wherein the at least one surveying sensor comprises at least one sonar system.

17. The method of claim 13, wherein the vessel is uncrewed.

18. The method of claim 13, further comprising a launch and recovery system for use of a remotely operated vessel/vehicle.

19. The method of claim 13, wherein the at least one surveying sensor comprises at least one sonar system being positioned in the at least one lifting hydrofoil at a back region of the at least one lifting hydrofoil relative to its intended direction of movement.

20. The method of claim 13, wherein the at least one lifting hydrofoil extends in a lateral direction between a first and second distal end, and wherein the at least one lifting hydrofoil comprises a front end and a tail end, extending in a movement direction substantially orthogonal to the lateral direction, wherein a centre point is defined between the first and second distal ends, and wherein the connection structure connects to the at least one lifting hydrofoil at the centre point.

21. The method of claim 13, wherein the at least one lifting hydrofoil comprises a bottom surface, wherein the bottom surface comprises an acoustically transparent window, and wherein the at least one lifting hydrofoil comprises an acoustic sensor.

22. The method of claim 13, wherein the at least one lifting hydrofoil comprises a rigid internal skeleton structure.

23. The method of claim 13, wherein the connection structure is arranged to adapt distance between the at least one lifting hydrofoil and the hull of the vessel.

24. A subsea surveying system comprising:
at least one lifting hydrofoil; and
a connection structure for connecting the at least one lifting hydrofoil to a hull of a vessel, the connection structure being arranged to translate a lifting force from the at least one lifting hydrofoil to the hull of the vessel,
wherein the at least one lifting hydrofoil comprises at least one surveying sensor.

25. The system of claim 24, wherein the at least one surveying sensor comprises at least one sonar system.
